(19) United States
(12) Patent Application Publication
(10) Pub. No.: US 2015/0315006 A1
(43) Pub. Date: Nov. 5, 2015

(54) COMMON DISPENSING NOZZLE ASSEMBLY

(71) Applicant: The Coca-Cola Company, Atlanta, GA (US)

(72) Inventor: Lawrence B. Ziesel, Woodstock, GA (US)

(73) Assignee: The Coca-Cola Company, Atlanta, GA (US)

(21) Appl. No.: 14/265,632

(22) Filed: Apr. 30, 2014

(51) Int. Cl. B67D 1/00

(52) U.S. Cl. CPC B67D 1/0021

(57) ABSTRACT

The present application provides a dispensing nozzle assembly. The dispensing nozzle assembly may include a core module with a diluent path and a sweetener path, an injector ring with a number of micro-ingredient paths and a number of macro-ingredient paths surrounding the core module, and a target assembly positioned about the core module.

### TECHNICAL FIELD

The present application and the resultant patent relates generally to nozzle assemblies for beverage dispensers sand more particularly relates to multi-flavor or multi-fluid dispensing nozzle assemblies capable of dispensing a wide number of different types of fluids.

### BACKGROUND OF THE INVENTION

Current post-mix beverage dispensing nozzles generally mix streams of syrup, concentrate, sweetener, bonus flavors, other types of flavoring, and other ingredients with water or other types of diluent by flowing the syrup stream down the center of the nozzle with the water stream flowing around the outside. The syrup stream is directed downward with the water stream such that the streams mix as they fall into a cup.

There is a desire for a beverage dispensing system as a whole to provide as many different types and flavors of beverages as may be possible in a footprint that may be as small as possible. Preferably, such a beverage dispensing system may provide as many beverages as may be available on the market in prepackaged bottles, cans, or other types of containers.

In order to accommodate this variety, the dispensing nozzles need to accommodate fluids with different viscosities, flow rates, mixing ratios, temperatures, and other variables. Current dispensing nozzle assemblies may not be able to accommodate multiple beverages with a single nozzle design and/or the dispensing nozzle assembly may be designed for specific types of fluid flow. One known means of accommodating differing flow characteristics is shown in commonly owned U.S. Pat. No. 7,383,966 that describes the use of replaceable fluid modules that are sized and shaped for specific flow characteristics. U.S. Pat. No. 7,383,966 is incorporated herein by reference in full. Even more variety and more fluid streams may be employed in commonly owned U.S. Pat. No. 7,578,415 that shows the use of a number of tertiary flow assemblies. U.S. Pat. No. 7,578,415 also is incorporated herein by reference in full.

Recent improvements in beverage dispensing technology have focused on the use of micro-ingredients. With micro-ingredients, the traditional beverage bases may be separated into their constituent parts at much higher dilution or reconstitution ratios. These micro-ingredients then may be stored in much smaller packages and stored closer to, adjacent to, or within the beverage dispenser itself. The beverage dispenser preferably may provide the consumer with multiple beverage options as well as the ability to customize his or her beverage as desired.

Beverage dispensers incorporating such highly concentrated micro-ingredients have proven to be highly popular with consumers. One example of the use of such micro-ingredients is shown in commonly owned U.S. Pat. No. 7,757,896 to Carpenter, et al., entitled “BEVERAGE DISPENSING SYSTEM.” U.S. Pat. No. 7,757,896 is incorporated herein by reference herein in full. Such a dispenser thus employs the use of a dispensing nozzle assembly that can accommodate multiple streams of micro-ingredients as well as streams of macro-ingredients such as sweeteners and diluent. Such a dispensing nozzle assembly is shown in commonly-owned U.S. Pat. No. 7,866,509. U.S. Pat. No. 7,866,509 is incorporated herein by reference in full. Likewise, such micro-ingredient technology is incorporated in the highly popular “FREESTYLE®” refrigerated beverage dispensing units provided by The Coca-Cola Company of Atlanta, Ga. The “FREESTYLE®” refrigerated beverage dispensing units can dispense over 125 brands without the need for extensive storage space.

There is thus a desire for a dispensing nozzle assembly to accommodate even more and different types of fluids that may pass therethrough. The dispensing nozzle assembly preferably may accommodate this variety while still providing good mixing and easy cleaning.

### SUMMARY OF THE INVENTION

The present application and the resultant patent thus provide a dispensing nozzle assembly. The dispensing nozzle assembly may include a core module with a diluent path and a sweetener path, an injector ring with a number of micro-ingredient paths and a number of macro-ingredient paths surrounding the core module, and a target assembly positioned about the core module.

The present application and the resultant patent further provide a method of providing a number of different beverages. The method may include the steps of providing a flow of diluent to a dispensing nozzle assembly, providing a flow of sweetener to the dispensing nozzle assembly, providing a flow of micro-ingredients to the dispensing nozzle assembly, providing a flow of beverage syrup to the dispensing nozzle assembly, and flowing any combination of the flow of diluent, the flow of sweetener, the flow of micro-ingredients, and/or the flow of beverage syrup so as to create the number of beverages.

The present application and the resultant patent further provide a dispensing nozzle assembly. The dispensing nozzle assembly may include a diluent/sweetener module with a diluent path and a sweetener path, an injector ring with a number of micro-ingredient chambers and a number of macro-ingredient chambers surrounding the diluent/sweetener module, and a target assembly positioned about the diluent/sweetener module.

These and other features and improvements of the present application and the resultant patent will become apparent to one of ordinary skill in the art upon review of the following detailed description when taken in conjunction with the several drawings and the appended claims.

### BRIEF DESCRIPTION OF THE DRAWINGS

FIG. 1 is a perspective view of a dispensing nozzle assembly as is described herein.

FIG. 2 is a perspective view of an injector upper ring of the dispensing nozzle assembly of FIG. 1.

FIG. 3 is a top plan view of the injector upper ring of FIG. 2.

FIG. 4 is a further perspective view of the injector upper ring of FIG. 2

FIG. 5 is a bottom plan view of the injector upper ring of FIG. 2.

FIG. 6 is a side cross-sectional view of the injector upper ring of FIG. 2.

FIG. 7 is a perspective view of an injector lower ring of the dispensing nozzle assembly of FIG. 1.

FIG. 8 is a top plan view of the injector lower ring of FIG. 7.

FIG. 9 is a further perspective view of the injector lower ring of FIG. 7.

FIG. 10 is a bottom plan view of the lower injector ring of FIG. 7.

FIG. 11 is a partial side cross-sectional view of the injector lower ring of FIG. 7.

FIG. 12 is a partial side cross-sectional view of the injector lower ring of FIG. 7.

FIG. 13 is a side cross-sectional view of the diluent/sweetener module and the target assembly of the dispensing nozzle assembly of FIG. 1.

FIG. 14 is a perspective view of the injector lower ring and the target assembly of the dispensing nozzle assembly of FIG. 1.

### DETAILED DESCRIPTION

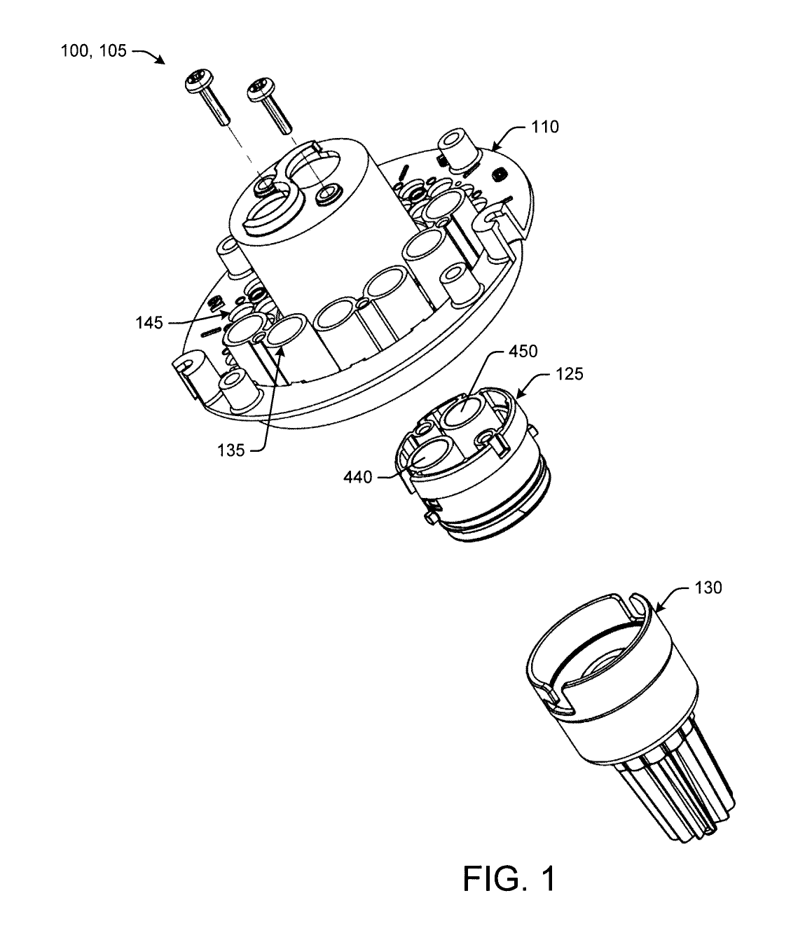

Referring now to the drawings, in which like numerals refer to like elements throughout the several views, FIG. 1 shows an example of a dispensing nozzle assembly 100 as is described herein. The dispensing nozzle assembly 100 may be used as part of a beverage dispenser for dispensing many different types of beverages or other types of fluids. Specifically, the dispensing nozzle assembly 100 may be used with diluents, macro-ingredients, micro-ingredients, and other types of fluids. The diluents generally include plain water (still water or non-carbonated water), carbonated water, and other fluids. The dispensing nozzle assembly 100 may be a common dispensing nozzle assembly 105. The term “common” is used herein to signify that the common dispensing nozzle assembly 105 may be commonly used with many different types of beverages and beverage dispensers.

Generally described, the macro-ingredients may have reconstitution ratios in the range from full strength (no dilution) to about six (6) to one (1) (but generally less than about ten (10) to one (1)). The macro-ingredients may include sugar syrup, HFCS (“High Fructose Corn Syrup”), concentrated extracts, purees, and similar types of ingredients. Other ingredients may include dairy products, soy, and rice concentrates. Similarly, a macro-ingredient base product may include the sweetener as well as flavorings, acids, and other common components as a beverage syrup. The beverage syrup with sugar, HFCS, or other macro-ingredient base products generally may be stored in a conventional bag-in-box container remote from the dispenser. The viscosity of the macro-ingredients may range from about 1 to about 10,000 centipoise and generally over 100 centipoises when chilled. Other types of macro-ingredients may be used herein.

The micro-ingredients may have reconstitution ratios ranging from about ten (10) to one (1) and higher. Specifically, many micro-ingredients may have reconstitution ratios in the range of about 20:1, to 50:1, to 100:1, to 300:1, or higher. The viscosities of the micro-ingredients typically range from about one (1) to about six (6) centipoise or so, but may vary from this range. Examples of micro-ingredients include natural or artificial flavors; flavor additives; natural or artificial colors; artificial sweeteners (high potency, nonnutritive, or otherwise); antifoam agents, nonnutritive ingredients, additives for controlling tartness, e.g., citric acid or potassium citrate; functional additives such as vitamins, minerals, herbal extracts, nutricuticals; and over the counter (or otherwise) medicines such as pseudoephedrine, acetaminophen; and similar types of ingredients. Various types of alcohols may be used as either macro- or micro-ingredients. The micro-ingredients may be in liquid, gaseous, or powder form (and/or combinations thereof including soluble and suspended ingredients in a variety of media, including water, organic solvents, and oils). Other types of micro-ingredients may be used herein.

The dispensing nozzle assembly 100 may be largely modular in nature. The dispensing nozzle assembly 100 may include an injector ring 110. The injector ring may include an upper injector ring 115 and a lower injector ring 120. The respective injector rings 115, 120 may be made out of a thermoplastic such as polypropylene and the like. Other types of food grade materials may be used herein. The injector rings 115, 120 may be injection molded or manufactured via other conventional techniques. The injector rings 115, 120 may be fastened together via laser welding techniques. Other types of fastening techniques may be used herein.

The dispensing nozzle assembly 100 also may have a core or a diluent/sweetener module 125 in communication with a target assembly 130. The diluent/sweetener module 125 and the target assembly 130 also may be made out of a thermoplastic such as polypropylene and the like. Other types of food grade materials may be used herein. The diluent/sweetener module 125 and the target assembly 130 may be injection molded or manufactured via other conventional techniques. The diluent/sweetener module 125 and the target assembly 130 may be in communication with the upper and lower injector rings 115, 120 as will be described in more detail below. Other components and other configurations may be used herein.

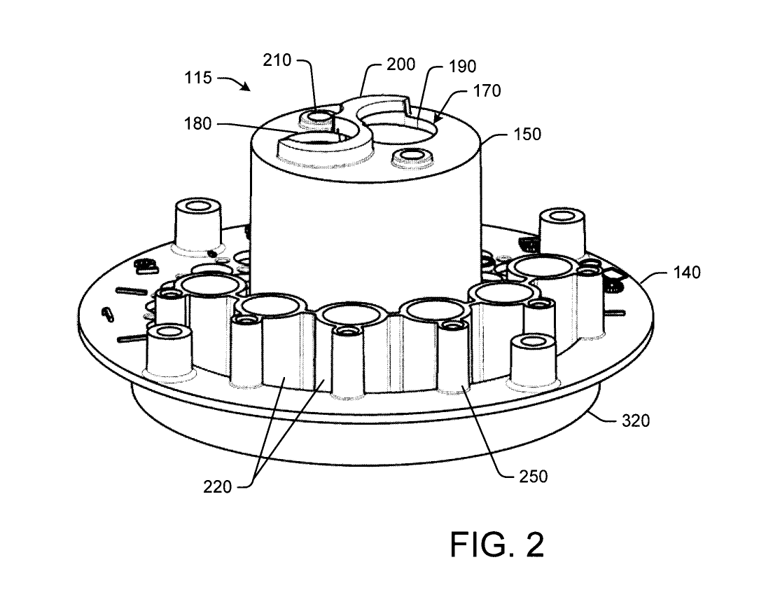

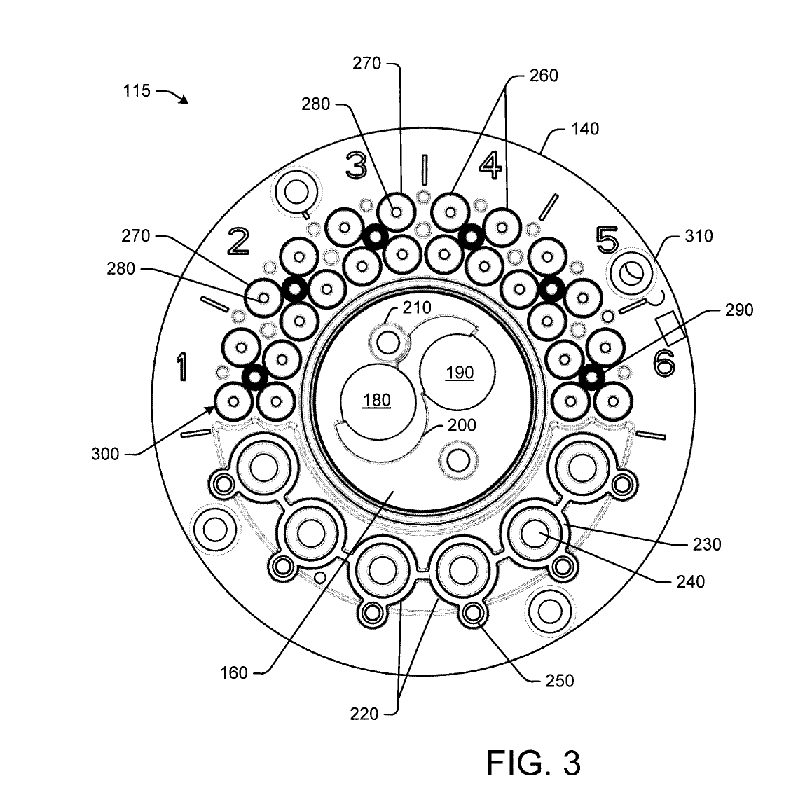

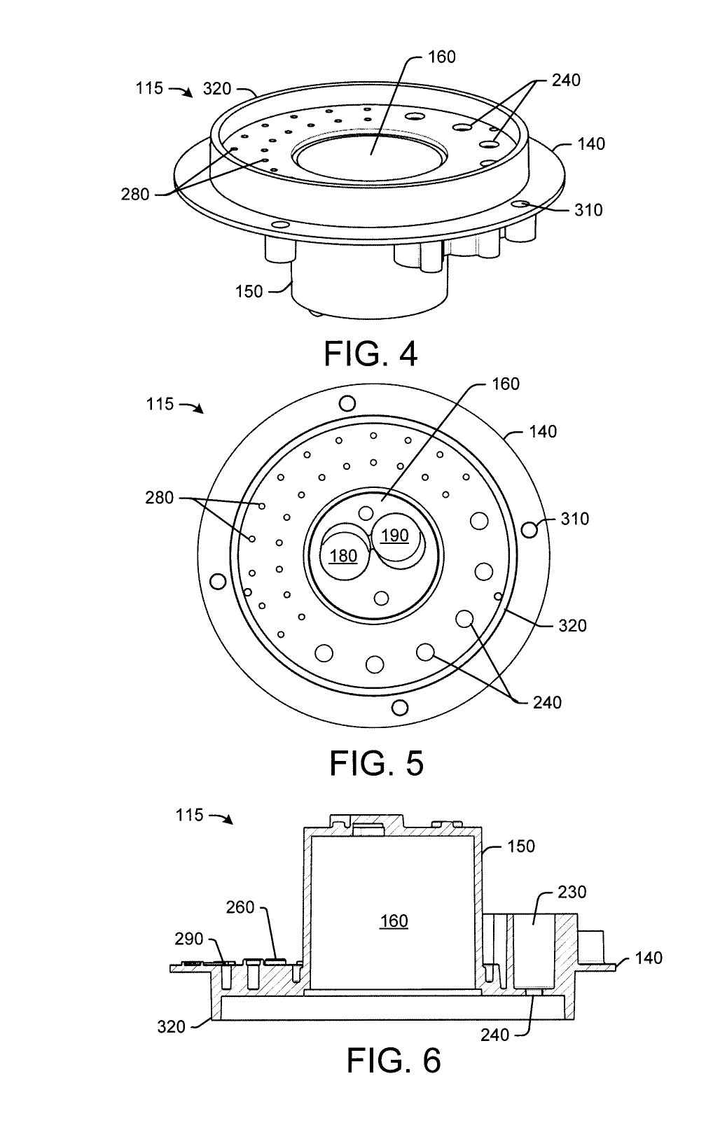

The upper and lower injector rings 115, 120 may define a number of macro-ingredient paths 135 and a number of micro-ingredient paths 145 therethrough. FIGS. 2-6 show an example of the upper injector ring 115. The upper injector ring 115 may be largely plate-like 140 in shape. A middle column 150 may rise through the middle of the plate 140. The middle column 150 may define a fluid chamber 160 therein. The middle column 150 may have a number of fluid inlets 170 on the top thereof. One of the fluid inlets 170 may be a diluent inlet 180 and the other may be a sweetener inlet 190. The sweetener inlet 190 may be primarily used for a flow of HFCS but other types of sweeteners may be used herein. Other types of fluids also may be used herein. Each of the fluid inlets 170 may have a semicircular fitment retention feature 200 extending partially therearound. The fitment retention feature 200 allows for the attachment of a fluid line to the fluid inlets 170. The middle chamber 160 may extend from the fluid inlets 170 out through the bottom of the plate 140. A number of fastener apertures 210 may be positioned about the top of the middle column 150. The fastener apertures 210 may be used to attach the diluent/sweetener module 125 therein. The plate 140, the middle column 150, and the fluid chamber 160 may have any suitable size, shape, and configuration.

The upper injector ring 115 may include a number of macro-ingredient ports 220 of the macro-ingredient path 135. In this example, there may be six (6) macro-ingredient ports 220 although any number of ports may be used herein. The macro-ingredient ports 220 may be used and sized primarily for traditional beverage syrups typically housed in a bag-in-box as described above although any type of macro-ingredient may be used herein. The macro-ingredient ports 220 may be largely circular in shape with a macro-ingredient inlet 230 at a top thereof and a macro-ingredient outlet 240 at a bottom thereof. The macro-ingredient outlet 240 may have a narrower diameter than the macro-ingredient inlet 230 so as to control the velocity and the back pressure of the flow of macro-ingredients therethrough. Each of the macro-ingredient ports 220 may have one or more macro-ingredient line fastener apertures 250 positioned thereabout. The macro-ingredient line fastener apertures 250 allow a macro-ingredient line to be secured thereto. The macro-ingredient ports 220 may have any suitable size, shape, and configuration.

The upper injector ring 115 also may have a number of micro-ingredient ports 260 of the micro-ingredient path 145. In this example, six (6) sets of four (4) micro-ingredients ports 260 are shown although any number of the micro-ingredient ports 260 may be used herein. The micro-ingredient ports 260 may be used and sized primarily for use with micro-ingredients. The micro-ingredient ports 260 may be largely circular in shape with a micro-ingredient inlet 270 at a top thereof and a micro-ingredient outlet 280 at a bottom thereof. The micro-ingredient outlet 280 may have a smaller diameter than the micro-ingredient inlet 270 so as to control the velocity and the back pressure of the flow of micro-ingredients therethrough. Each of the micro-ingredient ports 260 may have one or more micro-ingredient line fastener apertures 290 positioned thereabout. The micro-ingredient line fastener apertures 290 allow a micro-ingredient line to be secured thereto. The micro-ingredient ports 260 may be arranged in a quad configuration 300 of a set of four (4) ports. The quad configuration 300 may accommodate a quad tube assembly such as that shown in U.S. Pat. No. 7,866,509 referenced above. The micro-ingredient ports 260 may have any suitable size, shape, or configuration.

The plate 140 of the upper injector ring 115 may have a number of nozzle fastener apertures 310. The nozzle fastener apertures 310 may allow the dispensing nozzle assembly 100 to be attached to a beverage dispenser and the like. The plate 140 also may have a descending flange 320. The descending flange 320 may encircle the macro-ingredient ports 220 and the micro-ingredient ports 260. Other components and other configurations may be used herein

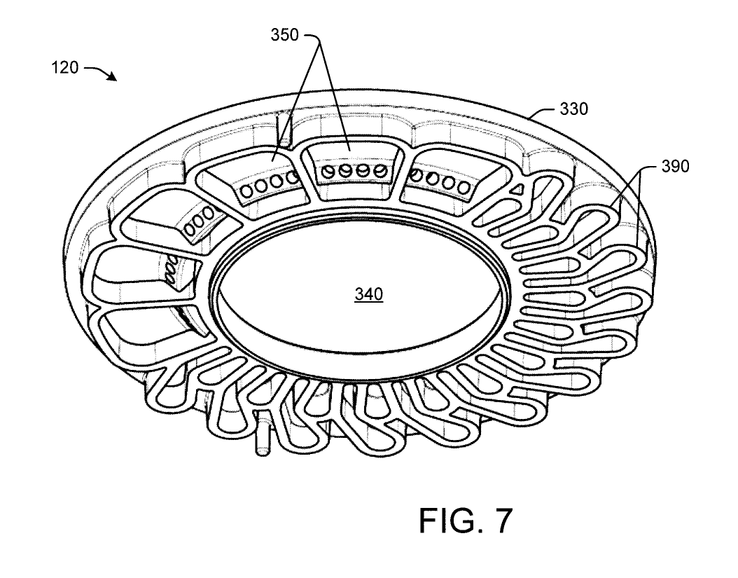

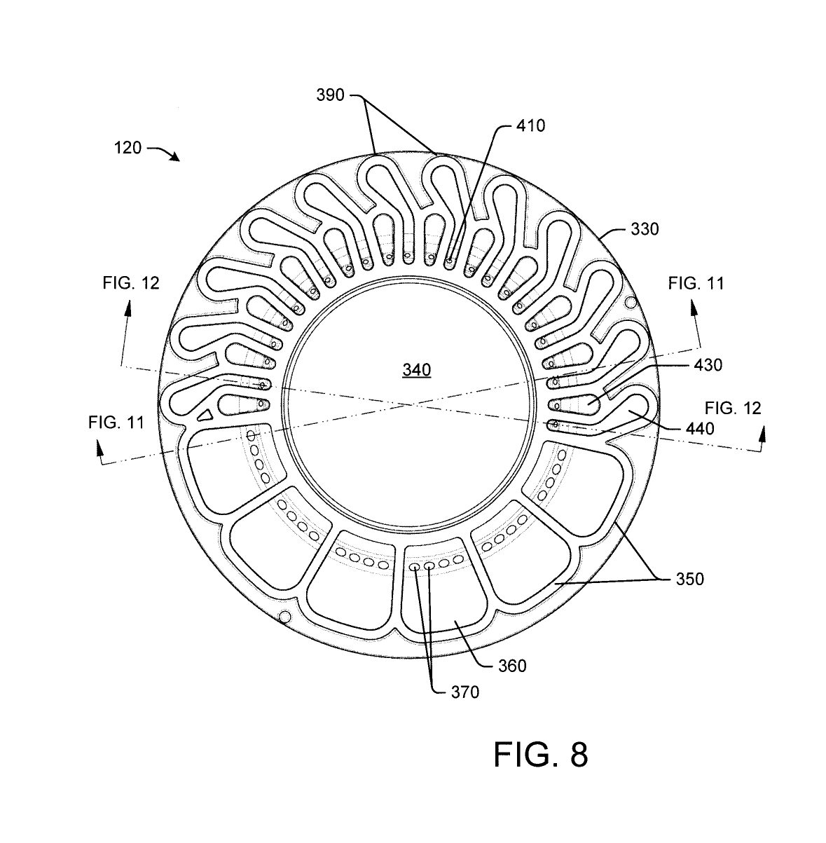

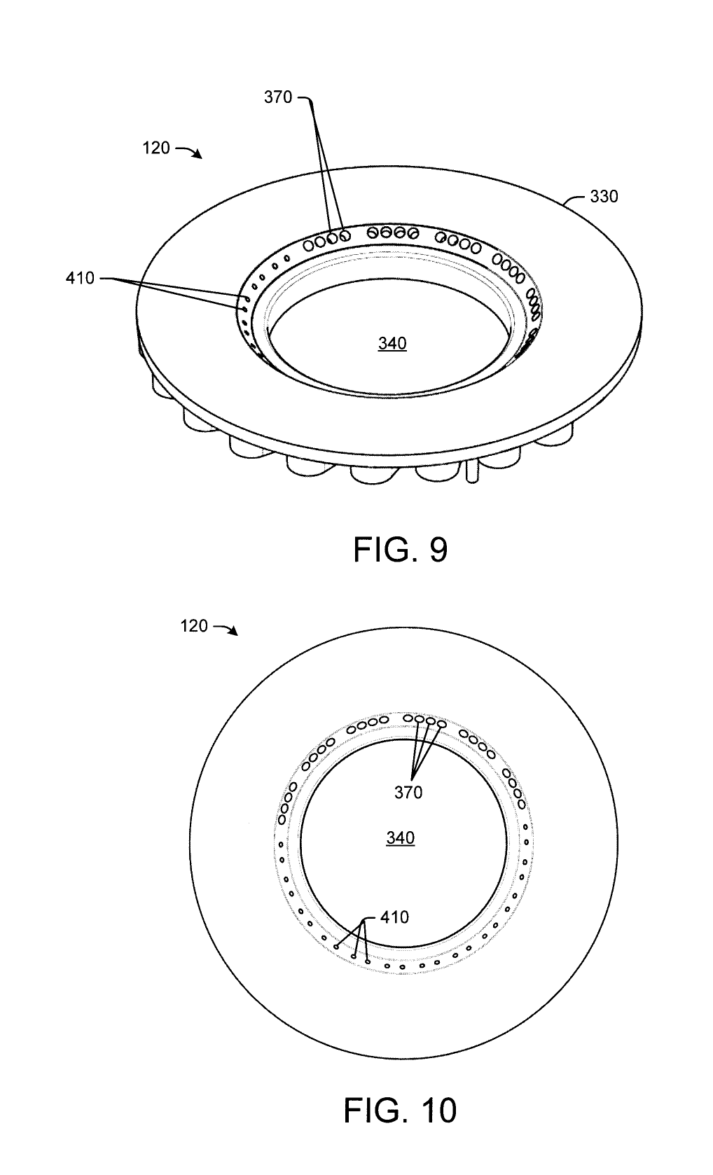

FIGS. 7-12 show an example of the lower injector ring 120. The lower injector ring 120 also may have a plate-like 330 shape. The plate 330 of the lower injector ring 120 may be sized to fit within the descending flange 320 of the upper injector ring 115 when the respective injector rings 115, 120 are combined. The lower injector ring 120 may have a middle aperture 340 in the middle thereof. The middle aperture 340 may be sized and shaped so as to align with the diluent/sweetener module 125 and the target assembly 130. Other components and other configurations may be used herein.

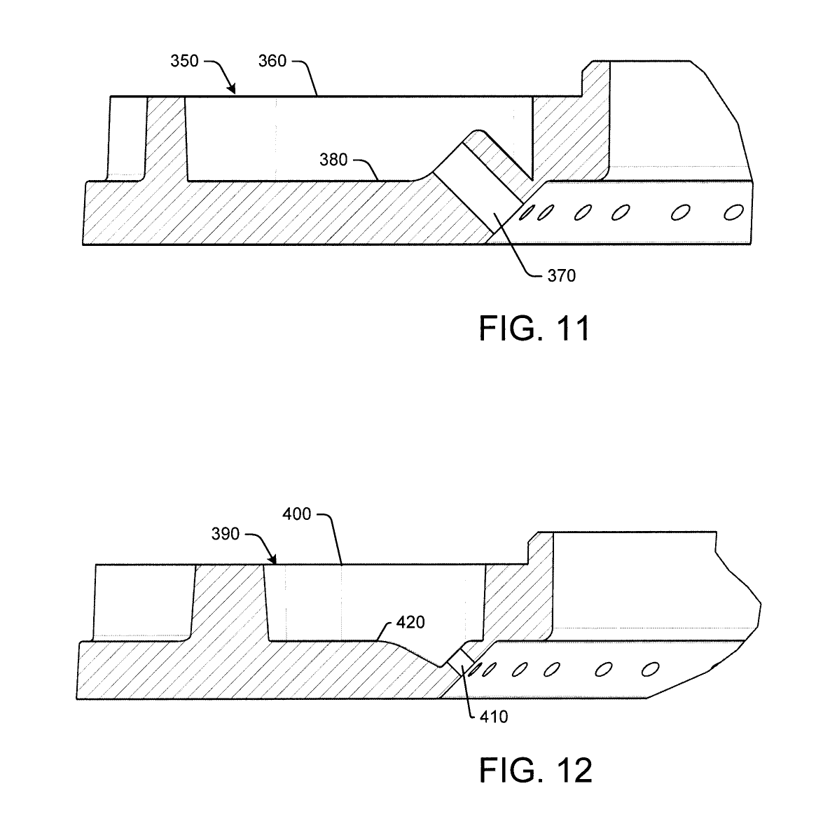

The lower injector ring 120 may include a number of macro-ingredient chambers 350 of the macro-ingredient path 135. In this example, six (6) macro-ingredient chambers 350 are shown although any number of the macro-ingredient chambers 350 may be used herein. The macro-ingredient chambers 350 may have an open end 360. The open end 360 may be open in whole or in part and may align with the outlets 240 of the macro-ingredient ports 220 of the upper injector ring 115. Each macro-ingredient chamber 350 may have a macro-ingredient dispensing port 370 about a bottom end 380 thereof. As shown, each macro-ingredient chamber 350 may have a number of macro-ingredient dispensing ports 370. Given such, there may be a one to many relationship between the macro-ingredient outlet 240 and the macro-ingredient dispensing ports 370. The macro-ingredient dispensing ports 370 may have a diameter sized so as to control the velocity and the back pressure of the flow of macro-ingredients therethrough. As is shown in FIG. 11, the macro-ingredient dispensing ports 370 may be angled such that the macro-ingredients may flow towards the target assembly 130 for mixing with the other ingredients dispensed herein. In some examples, the angle may be about a forty to about a fifty degree angle. Other angles may be used herein. The macro-ingredient chambers 350 and the macro-ingredient dispensing ports 370 may have any suitable size, shape, and configuration.

The lower injector ring 120 also may have a number of micro-ingredient chambers 390 of the micro-ingredient path 145. Each of the micro-ingredient chambers 390 may have an open end 400. The open end 400 may be open in whole or in part and may align with the micro-ingredient outlets 280 of the micro-ingredient ports 260 of the upper injector ring 115. Each of the micro-ingredient chambers 290 may have a micro-ingredient dispensing port 410 at a bottom end 420 thereof. The micro-ingredient dispensing ports 410 may have a diameter sized so as to control the velocity and the back pressure of the flow of micro-ingredients therethrough. As is shown in FIG. 12, the micro-ingredient dispensing ports 410 may be angled such that the micro-ingredients may flow towards the target assembly 130 for mixing with the other ingredients dispensed herein. In this example, the micro-ingredient chambers 390 may include a number of first chambers 430 with a first size and shape and a number of second chambers 440 with a second or an extended size and shape. The respective chambers 430, 440 accommodate the positioning of the micro-ingredient ports 260 on the upper injector ring 115. The micro-ingredient chambers 390 and the micro-ingredient dispensing ports 410 may have any suitable size, shape, and configuration. Other components and other configurations may be used herein.

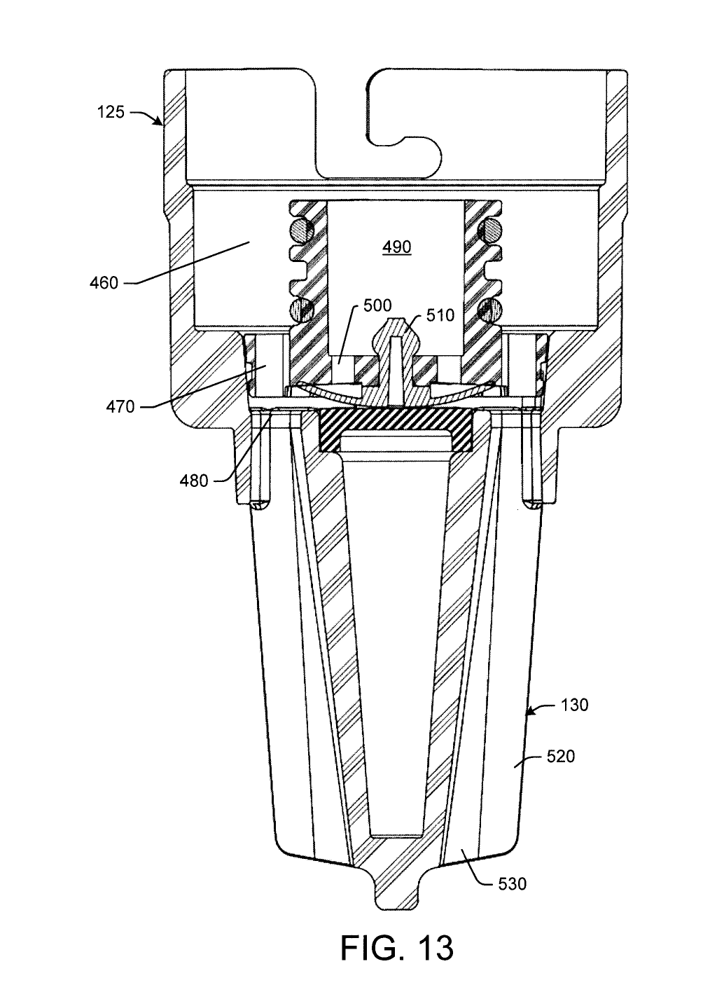

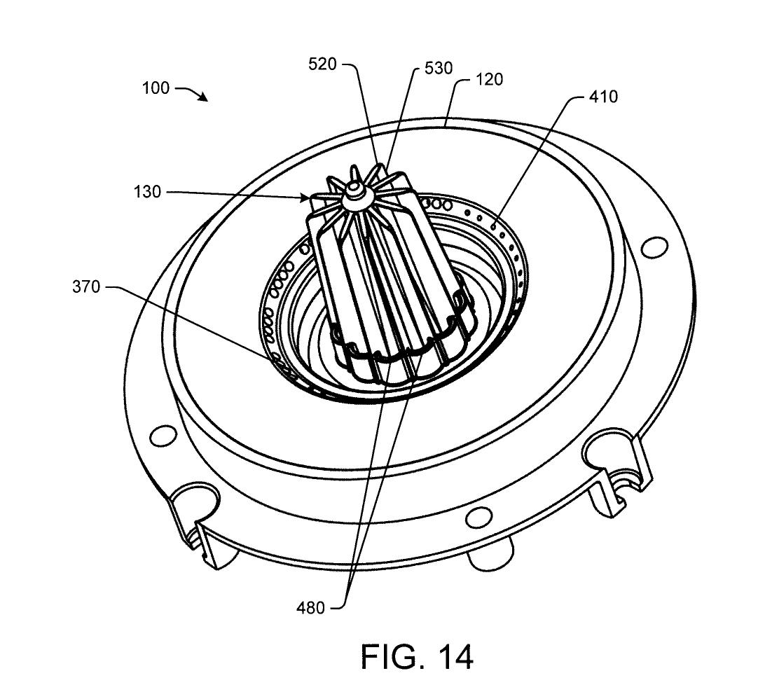

FIGS. 1 and 13 show an example of the diluent/sweetener module 125. The diluent/sweetener module 125 may be sized and shaped to be positioned within the fluid chamber 160 of the middle column 150 of the upper injector ring 115. The diluent/sweetener module 125 may have a diluent port 440 that aligns with the diluent inlet 180 and a sweetener port 450 that aligns with the sweetener inlet 190 of the middle column 150. The diluent port 440 may lead to an annular diluent chamber 460. The annular diluent chamber 460 may have a number of diluent chamber ports 470 at a bottom thereof. The diluent chamber ports 470 may lead to a number of target ports 480 positioned about the target assembly 130. The sweetener port 450 may align with a sweetener chamber 490. The annular diluent chamber 460 may surround the sweetener chamber 490 in whole or in part. The sweetener chamber 490 may have a number of sweetener chamber ports 500 at a bottom thereof. The flow of sweetener through the sweetener chamber 490 and the sweetener chamber ports 500 may be controlled by an umbrella valve 510 or other type of flow control device. The sweetener chamber ports 500 may align with the target ports 480. The diluent/sweetener module 125, and the components thereof, may have any suitable size, shape, or configuration. Other components and other configurations may be used herein.

FIGS. 1, 13, and 14 show an example of the target assembly 130. The target assembly 130 may be positioned below the lower injection ring 120. The target assembly 130 may include a number of vertically extending fins 520 that extend into a largely star-shaped appearance as viewed from the bottom. The fins 520 form a number of U or V-shaped channels 530. The channels 530 may aligns with the target ports 480 of the diluent/sweetener module 125 and in range of the macro-ingredient dispensing ports 370 and the micro-ingredient dispensing ports 410. The target assembly 130 may have any suitable size, shape, or configuration. Other components and other configurations may be used herein.

In use, the upper injector ring 115 and the lower injector ring 120 may be combined so as to form the injector ring 110. The diluent/sweetener module 125 may be affixed within the middle column 150. The target assembly 130 may be fastened to the diluent/sweetener module 125 so as to form the common dispensing nozzle assembly 105. Any order of assembly may be used herein. Any type of fasteners or joinder techniques may be used herein. Other components and other configurations may be used herein.

A diluent may flow into the diluent inlet 180 of the middle column 150, into the diluent/sweetener module 125, and may be dispensed via the target ports 480 along the target assembly 130. A sweetener or other fluid may flow into the sweetener inlet 190, into the diluent/sweetener module 125, and may be dispensed via the target ports 480 along the target assembly 130. One or more macro-ingredients may flow into the macro-ingredient ports 220 of the upper injector ring 150, into the macro-ingredient chambers 350 of the lower injector ring 130, and may be dispensed via the macro-dispensing ports 370 towards the target assembly 130. Likewise, micro-ingredients may flow into the micro-ingredient ports 260 of the upper injector ring, into the micro-ingredient chambers 390 of the lower injector ring 130, and may be dispensed via the micro-ingredient dispensing ports 410 towards the target assembly 130. The diluent, the sweetener, the macro-ingredients, and the micro-ingredients all may mix as they flow and collide along the target assembly 130 and fall towards a consumer's cup or any other vessel.

The common dispensing nozzle assembly 105 thus may be used to dispense any number of beverages. For example, a carbonated soft drink may include a flow of carbonated water as a diluent via the diluent inlet 180 and a flow of a conventional beverage syrup via one of the macro-ingredient ports 220. Alternatively, the carbonated soft drink also may include the flow of carbonated water via the diluent inlet, a flow of sweetener via the sweetener inlet 190, and a number of flows of micro-ingredients via the micro-ingredient ports 260. Further, a tea or coffee beverage may be created via a flow of still water as the diluent, a flow of tea concentrate as a macro-ingredient or a micro-ingredient, and a flow of a sweetener as a macro-ingredient or a micro-ingredient. Any number and combination of different beverages may be produced herein in a fast and efficient manner.

The dispensing nozzle assembly 100 may dispense syrups/concentrates with reconstitution ratios of anywhere from about three (3) to one (1) to about one hundred fifty (150) to one (1) or higher. The number, size, and shape of the various ports and pathways herein may be varied and reconfigured as desired. The dispensing nozzle assembly 100 thus may be used with almost any type of beverage dispenser. For example, the dispensing nozzle assembly 100 may be used with a conventional syrup based dispenser, a micro-ingredient based dispenser, and/or a hybrid or other type of dispenser based upon availability or any type of operational parameters or needs. The dispensing nozzle assembly 100 may be original equipment or part of a retrofit. Multiple dispensing nozzles assemblies 100 may be used together herein in different configurations.

It should be apparent that the foregoing relates only to certain embodiments of the present application and the resultant patent. Numerous changes and modifications may be made herein by one of ordinary skill in the art without departing from the general spirit and scope of the invention as defined by the following claims and the equivalents thereof.

1. A dispensing nozzle assembly, comprising:
a core module;
the core module comprising a diluent path and a sweetener path;
an injector ring surrounding the core module;
the injector ring comprising a plurality of micro-ingredient paths and an plurality of macro-ingredient paths; and
a target assembly positioned about the core module.

2. The dispensing nozzle assembly of claim 1, wherein the injector ring comprises an upper injector ring and a lower injector ring.

3. The dispensing nozzle assembly of claim 1, wherein the injector ring comprises a middle column with the core module positioned therein.

4. The dispensing nozzle assembly of claim 3, wherein the middle column comprises a diluent inlet in communication with the diluent path and a sweetener inlet in communication with the sweetener path.

5. The dispensing nozzle assembly of claim 1, wherein the plurality of micro-ingredient paths comprises a micro-ingredient port and a micro-ingredient chamber.

6. The dispensing nozzle assembly of claim 5, wherein the micro-ingredient port comprises a inlet with a first diameter, an outlet with a second diameter, and wherein the first diameter is larger than the second diameter.

7. The dispensing nozzle assembly of claim 5, wherein the micro-ingredient chamber comprises a micro-ingredient dispensing port angled towards the target assembly.

8. The dispensing nozzle assembly of claim 1, wherein the plurality of micro-ingredient paths comprises a plurality of micro-ingredient chambers of a first size and a plurality of micro-ingredient chamber of a second size.

9. The dispensing nozzle assembly of claim 1, wherein the plurality of macro-ingredient paths comprises a macro-ingredient port and a macro-ingredient chamber.

10. The dispensing nozzle assembly of claim 9, wherein the macro-ingredient port comprises a inlet with a first diameter, an outlet with a second diameter, and wherein the first diameter is larger than the second diameter.

11. The dispensing nozzle assembly of claim 9, wherein the macro-ingredient chamber comprises a macro-ingredient dispensing port angled towards the target assembly.

12. The dispensing nozzle assembly of claim 1, wherein the sweetener path of the core module comprises a sweetener chamber with an umbrella valve thereabout.

13. The dispensing nozzle assembly of claim 1, wherein the core module comprises a plurality of target ports positioned about the target assembly.

14. The dispensing nozzle assembly of claim 1, wherein the target assembly comprises a plurality of ribs and a plurality of channels therein.

15. A method of providing a number of different beverages, comprising:
providing a flow of diluent to a dispensing nozzle assembly;
providing a flow of sweetener to the dispensing nozzle assembly;
providing a flow of micro-ingredients to the dispensing nozzle assembly;
providing a flow of beverage syrup to the dispensing nozzle assembly; and
flowing any combination of the flow of diluent, the flow of sweetener, the flow of micro-ingredients, and/or the flow of beverage syrup.

16. A dispensing nozzle assembly, comprising:
a diluent/sweetener module;
the diluent/sweetener module comprising a diluent path and a sweetener path;
an injector ring surrounding the diluent/sweetener module;
the injector ring comprising a plurality of micro-ingredient chambers and an plurality of macro-ingredient chambers; and
a target assembly positioned about the diluent/sweetener module.

17. The dispensing nozzle assembly of claim 16, wherein the micro-ingredient chamber comprises a micro-ingredient dispensing port angled towards the target assembly.

18. The dispensing nozzle assembly of claim 16, wherein the macro-ingredient chamber comprises a macro-ingredient dispensing port angled towards the target assembly.

19. The dispensing nozzle assembly of claim 16, wherein the plurality of micro-ingredient chambers comprises a plurality of micro-ingredient chambers of a first size and a plurality of micro-ingredient chambers of a second size.

20. The dispensing nozzle assembly of claim 16, wherein the diluent/sweetener module comprises a plurality of target ports positioned about the target assembly.

21. A nozzle for a beverage dispenser, comprising:
a central sweetener chamber;
the central sweetener chamber comprising a one way valve; and
an annular diluent chamber surrounding the central sweetener chamber;
the annular diluent chamber comprising a diluent input port and a plurality of aligned diluent output ports.

22. The nozzle of claim 21, wherein the central sweetener chamber comprises a sweetener input port.

23. The nozzle of claim 21, wherein the central sweetener chamber comprises a plurality of sweetener output ports in communication with the one way valve.

24. The nozzle of claim 23, wherein the plurality of sweetener output port is positioned about the plurality of diluent output ports.

25. The nozzle of claim 21, wherein the one way valve comprises an umbrella valve.

26. The nozzle of claim 21, wherein the annular diluent chamber surrounds the central sweetener chamber in whole or in part.

27. The nozzle of claim 21, further comprising a flow of high fructose corn syrup through the central sweetener chamber.

28. The nozzle of claim 21, further comprising a flow of a sugar solution through the central sweetener chamber.

29. The nozzle of claim 21, further comprising a target assembly positioned about the plurality of diluent output ports.

30. The nozzle of claim 21, further comprising an injector ring surrounding the annular diluent chamber in whole or in part.
